(19) United States
(12) Patent Application Publication
(10) Pub. No.: US 2013/0145268 A1
(43) Pub. Date: Jun. 6, 2013

(54) FRAME CONTROL

(71) Applicant: Timothy W. Kukulski, Oakland, CA (US)

(72) Inventor: Timothy W. Kukulski, Oakland, CA (US)

(73) Assignee: ADOBE SYSTEMS INCORPORATED, San Jose, CA (US)

(21) Appl. No.: 13/309,924

(22) Filed: Dec. 2, 2011

(51) Int. Cl. G06F 3/00

(52) U.S. Cl. 715/719

(57) ABSTRACT

A graphical user interface associated with a touch enabled device displays a first video track and a second video track. The first video track includes a first plurality of frames and the second video track including a second plurality of frames. Further, the touch enabled device receives a touch input that indicates a movement of the first video track relative to the second video track. In addition, in response to the touch input, the first video track is displayed in a modified position such that a first frame in the first plurality of frames is aligned with a second frame in the second plurality of frames.

### BACKGROUND

1. Field

This disclosure generally relates to video editing. More particularly, the disclosure relates to video editing in a computing environment.

2. General Background

Video editing is the process of editing a video after the production of a video. A video typically includes multiple video tracks, which each includes frames of the video. The video tracks are typically arranged in rows on a video editing system.

Current configurations for video editing are typically cumbersome and inefficient. In particular, a video editor, i.e., a user of video editing software, may receive multiple rows of frames to be edited on a computer. The video editor then typically views each row displayed on top of one another in a graphical user interface (“GUI”). To edit the different rows, the video editor has to move a mouse cursor with a conventional computer mouse over one row and then move the cursor to another row to line up the rows for editing purposes. However, this process is often tedious as the user has to typically move back and forth between rows multiple times to line the rows up properly. For example, the user may move the mouse cursor over a first row to move the first row to the right and then move the mouse cursor over a second row to move the second row to the left. The user may subsequently find that he or she has to again go back to move the first row a little bit more to the right or left to line up with the second row and may have to do so also with the second row. This process can continue onward as such for some time. In other words, for practical purposes, the user had to pick a track to adjust and adjust only that track in reference to the full composition or select the composition itself to navigate the composition.

### SUMMARY

In one aspect of the disclosure, a computer program product is provided. The computer program product includes a computer useable medium having a computer readable program. The computer readable program when executed on a computer causes the computer to display, at a graphical user interface associated with a touch enabled device, a first video track and a second video track. The first video track includes a first plurality of frames and the second video track including a second plurality of frames. Further, the computer readable program when executed on the computer causes the computer to receive, at the touch enabled device, a touch input that indicates a movement of the first video track relative to the second video track. In addition, the computer readable program when executed on the computer causes the computer to display, in response to the touch input, the first video track in a modified position such that a first frame in the first plurality of frames is aligned with a second frame in the second plurality of frames.

In another aspect of the disclosure, a process is provided. The process displays, at a graphical user interface associated with a touch enabled device, a first video track and a second video track. The first video track includes a first plurality of frames and the second video track including a second plurality of frames. Further, the process receives, at the touch enabled device, a touch input that indicates a movement of the first video track relative to the second video track. In addition, the process displays, in response to the touch input, the first video track in a modified position such that a first frame in the first plurality of frames is aligned with a second frame in the second plurality of frames. The process receives, at the touch enabled device, an additional touch input that indicates a movement of the second video track relative to the first video track such that the touch input and the additional input are received concurrently

In yet another aspect of the disclosure, a touch enabled device is provided. The touch enabled device includes a graphical user interface that displays a first video track and a second video track, displays, in response to a touch input, the first video track in a modified position such that a first frame in the first plurality of frames is aligned with a second frame in the second plurality of frames, and displays, in response to an additional touch input that indicates a movement of the second video track relative to the first video track such that the touch input and the additional input are received concurrently. The touch input indicates a movement of the first video track relative to the second video track. The touch enabled device also includes a processor that calculates the movement of the first video track relative to the second video track. The second video track is in a modified position such that the first frame in the first plurality of frames and the second frame in the second plurality of frames are aligned.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a frame control system.

FIG. 2 illustrates an expanded view of the touch enabled device illustrated in in FIG. 1.

FIGS. 3A-3E illustrate examples of possible user interactions with the touch enabled graphical user interface (“GUI”) of the touch enabled device illustrated in FIG. 2.

FIG. 3A illustrates the touch enabled GUI when the video tracks have been stopped or paused.

FIG. 3B illustrates user navigation of the video tracks illustrated in FIG. 3A.

FIG. 3C illustrates the first video track and the second video track of FIG. 3B being played.

FIG. 3D illustrates the first video track illustrated in FIG. 3C being stopped during play.

FIG. 3E illustrates the navigation of the first video track after being stopped as illustrated in FIG. 3D.

FIG. 4 illustrates a frame control configuration with proxy images.

FIG. 5 illustrates a process that may be utilized to provide frame control for a touch enabled device.

FIG. 6 illustrates a system configuration that may be utilized to provide frame control.

### DETAILED DESCRIPTION

A frame control configuration for a touch enabled device is provided. A touch enabled device may be utilized to slide different rows of frames in video tracks so that the frames in the different tracks line up. Further, touch gestures may be utilized to perform actions on those frame elements. In contrast with a conventional video editing system that utilizes a standard mouse device and only allows one row of frames to be moved at a time, the frame control configuration allows a user to move two rows concurrently and/or independently. For example, a user may utilize one hand to touch and move one row and utilize another hand to touch and move a different row concurrently. As a result, a user may effectively and easily line up the rows of frames rather than tediously going back and forth from row to row with a standard mouse device. A highly practiced user may utilize multiple fingers in order to adjust more than two tracks simultaneously. Alternatively, by utilizing multiple control surfaces, collaborators may adjust an arbitrary number of tracks simultaneously. Multi-user real-time collaboration may be provided either locally or remotely.

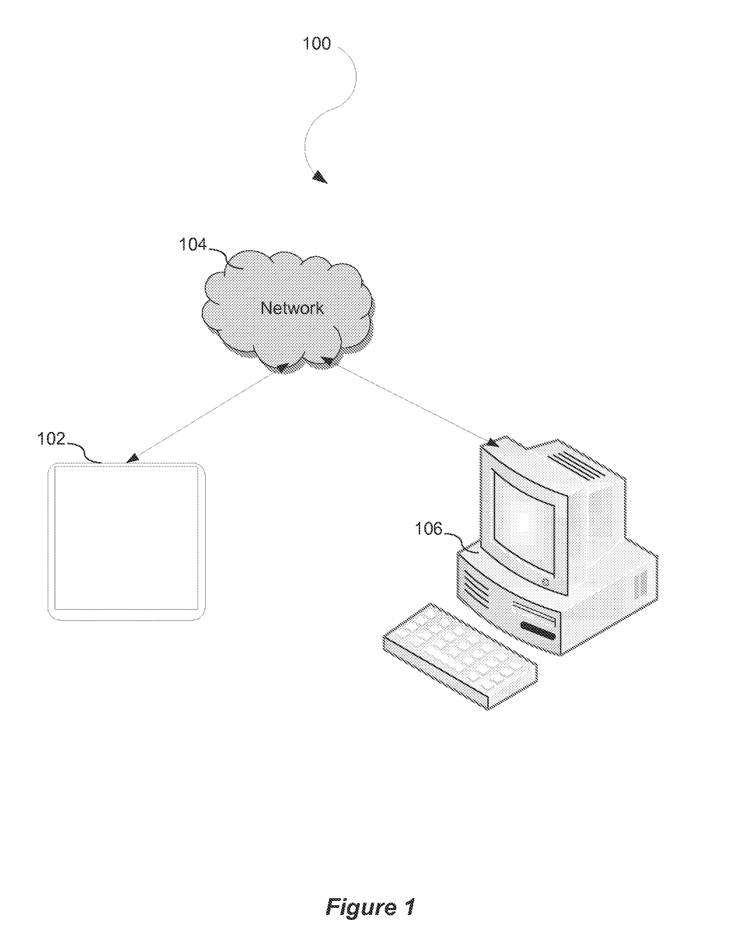

FIG. 1 illustrates a frame control system 100. The frame control system 100 includes a touch enabled device 102, a network 104, and a computing device 106. The system 100 illustrates an embodiment where video editing can be performed using a tablet device in conjunction with another computing device. However, it is understood that in other embodiments, video editing can be performed solely on the tablet device. The touch enabled device 102 may be a tablet device, smart phone, cell phone, personal digital assistant (“PDA”), personal computer (“PC”), laptop, or the like that allows a user to provide input via a touch enabled interface. For example, the user may utilize his or her fingers, a stylus, or the like to provide touch inputs to the touch enabled device. Further, the network 104 may be the Internet, a wireless network, a satellite network, a local area network (“LAN”), a wide area network (“WAN”), a telecommunications network, or the like. The computing device may be a PC, laptop, tablet device, smart phone, or the like.

In one embodiment, the computing device 106 is a video editing station. A user may utilize the computing device 106 to store and edit video frames. The touch enabled device 102 may interact with the computing device 106 to remotely perform video editing functionality. As an example, the touch enabled device 102 may have stored thereon a companion application, which allows the user to remotely control the video editing on the computing device 106 from the touch enabled device 102. The touch enabled device 102 may additionally or alternatively allow the user to retrieve the video frames from the computing device 106 for storage on the touch enabled device 102. A user may then perform the video editing locally on the touch enabled device and later upload the edited video images to the computing device 106. For example, a film editor may download a current set of video frames in a studio editing room from the computing device 106 to the touch enabled device 102. The film editor may then take the touch enabled device 102 to a film lot, make some edits, and show a film producer a preview of the edits for comments prior to uploading the edits to the computing device in the studio editing room for final cut of a film.

The network 104 may or may not be utilized. For example, the touch enabled device 102 may connect to the computing device 106 via a wireline connection. Further, Bluetooth, radio frequency (“RF”), or like wireless connections may be utilized.

Further, the computing device 106 may or may not be utilized. For example, all of the video editing may be performed directly on the touch enabled device 102.

In another embodiment, the system may additionally utilize synchronized clocks and knowledge of the performance and latency characteristics of individual wireless or wired networks, input devices, and displays devices to compensate for system lags during coordination of different display screens. By synchronizing clocks on each collaborating system, e.g., desktop device, mobile device, control surface, media server, etc., the exact start and end times for a user gesture and the exact video frame displayed at that time may be correlated, which allows for precise and accurate control even on slow or inconsistent networks. For example, if the system took one second to propagate a message with thirty video frames from a remote screen on the touch enabled device 102 to a main display of the computing device 106, this precisely known delay is accounted for when determining system response to an action. For example, a user may take an action to perform an edit on the touch enabled device 102. The system response of displaying the edit may be synchronized across the display of the touch enabled device 102 and the display of the computing device 106.

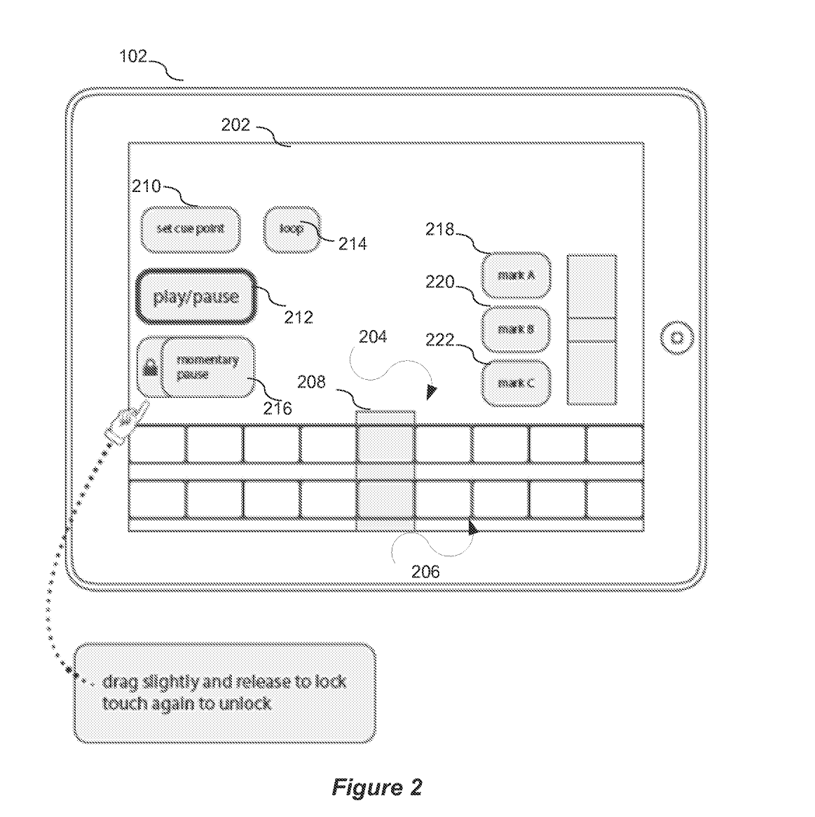

FIG. 2 illustrates an expanded view of the touch enabled device 102 illustrated in in FIG. 1. The touch enabled device 102 includes a touch enabled GUI 202 that allows a user to provide touch inputs for interaction. The touch enabled GUI 202 may display a plurality of video tracks of frames such as a first video track 204 and a second video track 206. A user may slide one or both the first video track 204 and the second video track 206 to align the video tracks. In one embodiment, the sliding may be performed without inertia. In other words, when the user stops sliding, the video tracks do not continue to slide according to inertia. The video tracks simply stop when the user ceases the sliding gesture. In an alternative embodiment, the video tracks may continue to slide according to inertia.

To help the video editor view the video tracks after edits, the video tracks may be played. In other words, the video tracks may be transformed from a group of frames into playable content. The video track itself or part of the video track may be replaced with the playable portion. Alternatively, a separate area may be utilized to display the playable video track.

In one embodiment, the user may set a cue point 208 by selecting a set cue point indicium 210. The cue point 208 may indicate an alignment point between the first video track 204 and the second video track 206. Accordingly, after the cue point 208 is set, the user may play both the first video track 204 and the second video track 206 at a constant alignment indicated by the cue point 208. The cue point may be set through the touch enabled GUI 202 or a GUI on the main display of the computing device 106 with which the touch enabled device 102 is communicating. Accordingly, an auto-cue feature may be utilized to either play once or loop after each change. The user may drag either track, a marker such as the cue point 208, or a cut point. Upon release, the video replays from the indicium, e.g., the cue point 208. The user may indicate a play or a pause command by selecting a play/pause indicium 212. Further, the user may select a loop indicium 214 to indicate a loop such that the first video track 204 and the second video track 206 continuously play. The user may also indicate a lock or momentary pause with a momentary pause indicium 216. For example, the user may drag the momentary pause indicium 216 and release the momentary pause indicium 216 to lock or touch the momentary pause indicium 216 to unlock. Further, in another embodiment, the user may set markers in addition to or in the alternative to the cue point 208. For example, a mark A indicium 218 may be utilized to mark a frame with the letter A, a mark B indicium 220 may be utilized to mark a frame with the letter B, and a mark C indicium 222 may be utilized to mark a frame with the letter C. The various indicia that are illustrated in FIG. 2 are optional or may be performed by like indicia. For example, the play command be requested from a menu rather than by selecting a button.

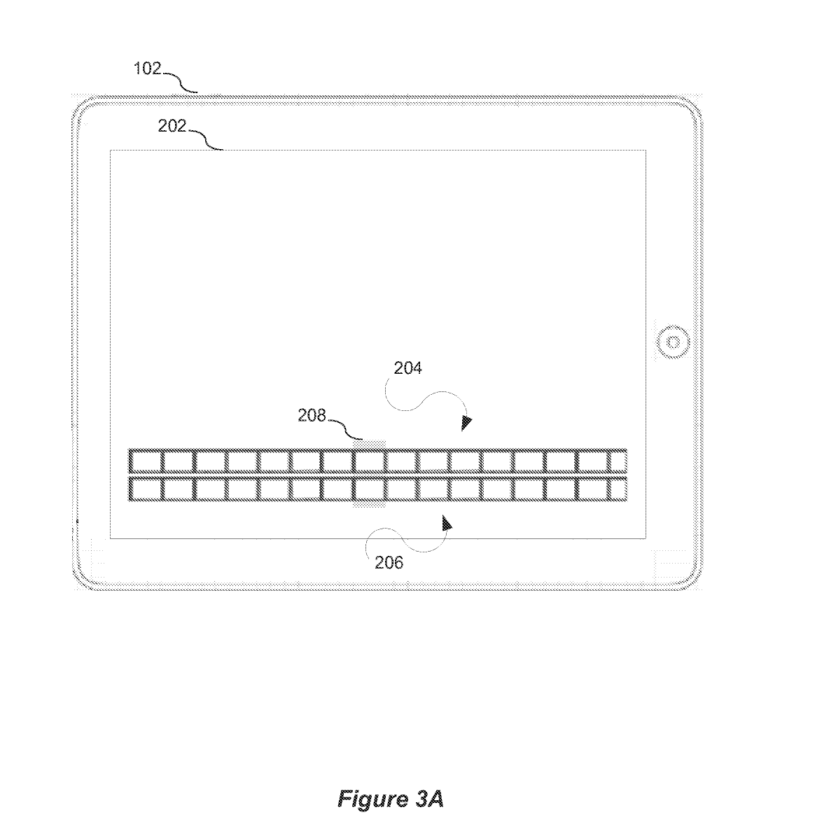

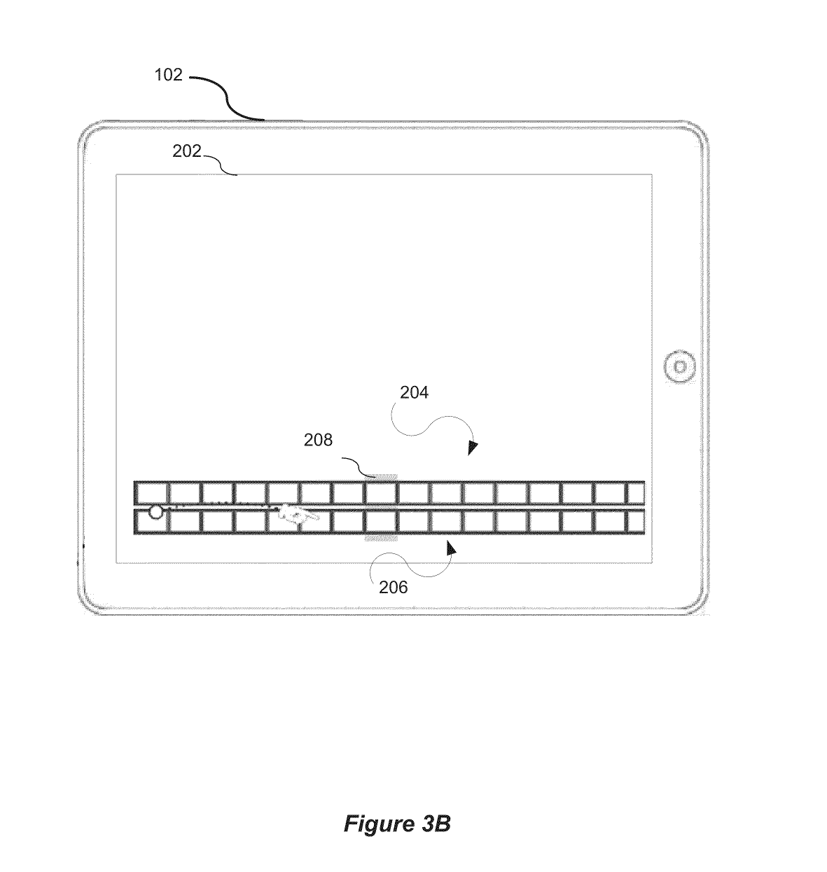

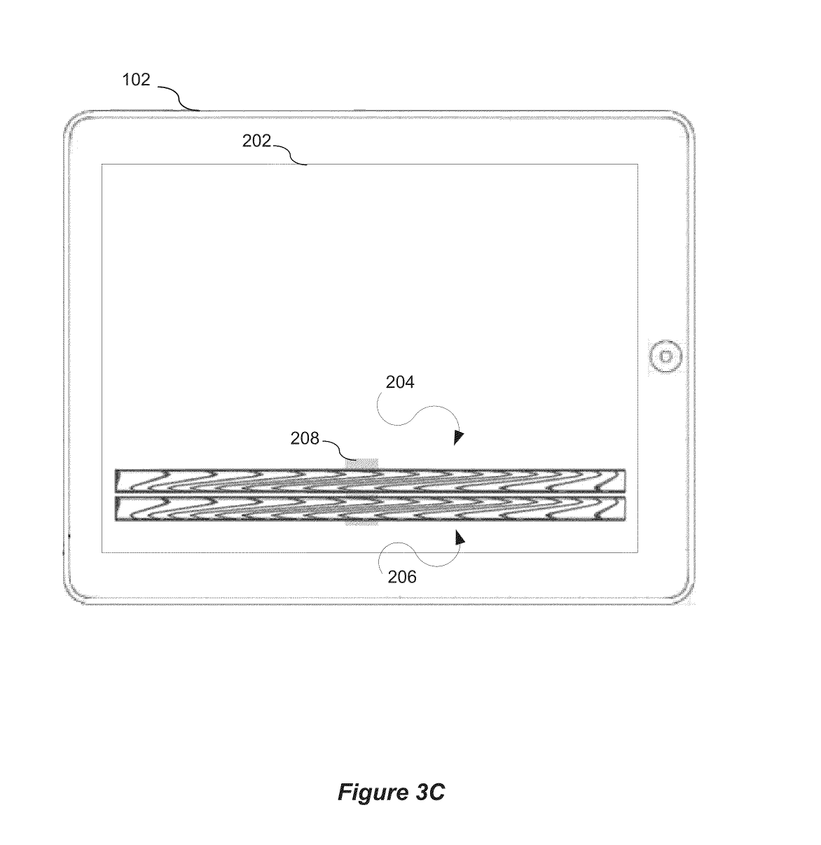

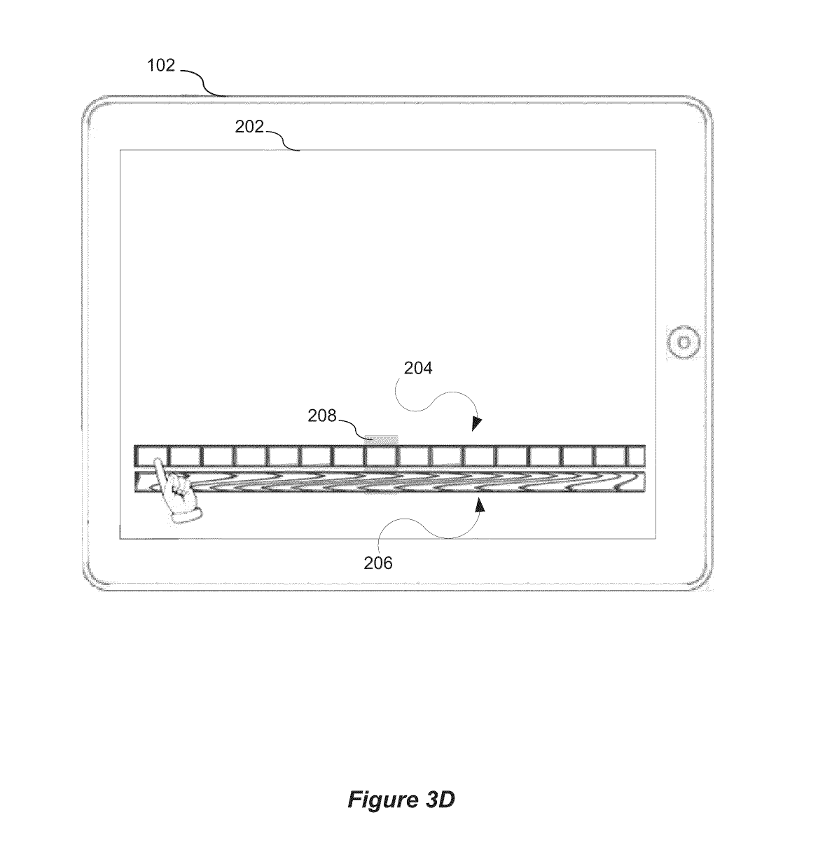

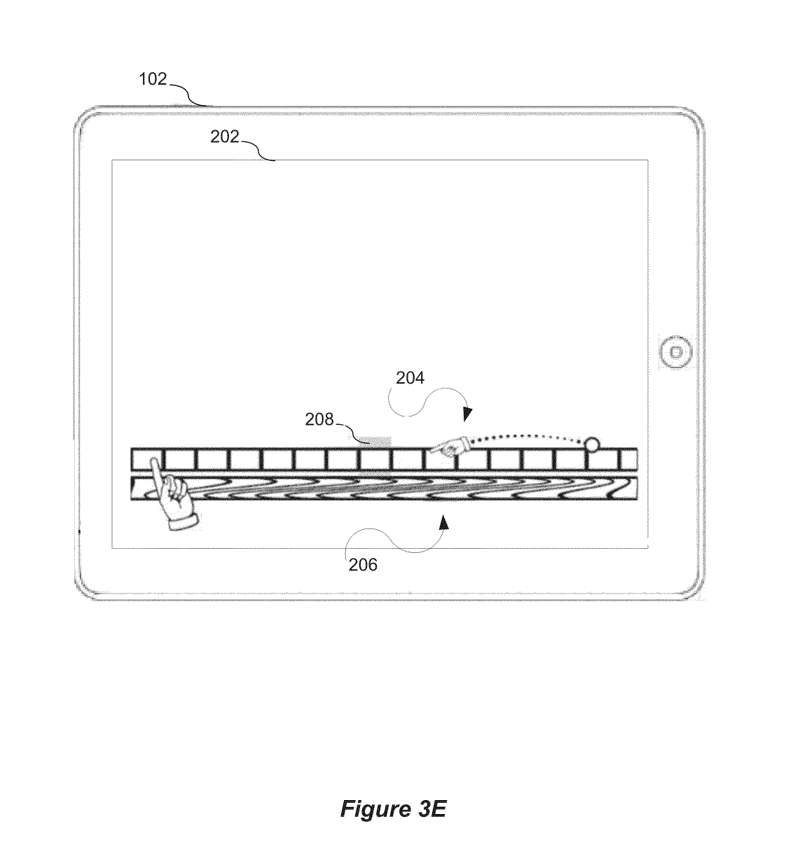

FIGS. 3A-3E illustrate examples of possible user interactions with the touch enabled GUI 202 of the touch enabled device 102 illustrated in FIG. 2. FIG. 3A illustrates the touch enabled GUI 202 when the video tracks have been stopped or paused. In one embodiment, when the video tracks are stopped or paused, the individual frames or a portion of the individual frames in a video track displayed as the touch enabled GUI 202 may not be large enough to display every frame in the video track at a single time. FIG. 3B illustrates user navigation of the video tracks illustrated in FIG. 3A. The user may touch anywhere on a video track and drag the video track with frame accuracy, i.e., by moving a particular frame to move the video track. Further, the user may drag multiple video tracks independently by utilizing different hands or different fingers of the same hand to drag different video tracks. Alternatively, the user may jump directly to a frame by tapping the frame. FIG. 3C illustrates the first video track 204 and the second video track 206 of FIG. 3B being played. In one embodiment, the video tracks may be displayed during play in a stylized fashion. For example, a stylized blurred frame tinted to the average color value of the current frame may be utilized. FIG. 3D illustrates the first video track 204 illustrated in FIG. 3C being stopped during play. The user may touch the first video track 204 with his or her finger to stop play. After play of the first video track 204 is stopped, each individual frame of the first video track 204 is displayed. However, as the user did not touch the second video track 206, play of the second video track 206 is not stopped. As a result, each individual frame of the first video track 204 is displayed whereas stylized blurred frames are displayed for play of the second video track 206. FIG. 3E illustrates the navigation of the first video track 204 after being stopped as illustrated in FIG. 3D. The user may provide a second touch input on the first video track 204, which allows for quick flipping between two positions. In other words, a user may be able to move frames to different portions of the first video track 204. The user may drag the frame indicated by the second touch input to the user's intended destination. Alternatively, the user may view the frame indicated by the second touch and then view the frame indicated by the first touch. The user may also utilize another finger on the hand that makes the second touch to tap to a frame of interest so that the user may view that frame.

A variety of options may be utilized for a stylized placeholder for playing video. The stylized placeholder, e.g., a cue, allows a user to select a point in a video track. As an example, the user may play the video track previous to or after the stylized placeholder. In a system without memory or bandwidth limitations, the filmstrips could update at full fidelity while each track is playing. Alternatively, the appearance of the film moving too fast to see may be simulated by applying a horizontal blur to each of the playing filmstrips, e.g., a blur simulating horizontal motion. For example, a Gaussian blur applied with a large horizontal radius and a vertical radius of zero may be utilized. For instance, a blurred/subsampled frame may be utilized as subsampling may be more extreme in the horizontal direction. Further, the average color of each line in the frame may be utilized for blurring/subsampling for horizontal subsampling. The average color of the frame may be utilized for blurring/subsampling for subsampling. Implementations of the system may utilize fast motion and/or motion blur to cover for extreme decimation of the data whether through subsampling or through highly aggressive compression. Given that memory and/or bandwidth limitations are possible, e.g., with respect to mobile or cloud environments, the amount of data utilized to display a useful representation of the filmstrip while video is playing may be limited.

When a playing track is displayed in a stylized manner, a clear and repeating marker may be shown to provide a strong visual cue as to the rate at which the frames are going by. Further, video compression technology may be utilized to reduce the network load that delivers the placeholder for playing the video. The sequence may be encoded at a very small spatial size and very high compression ratio with strategically placed keyframes in order to facilitate rapid delivery of a proxy stream of proxy images at the maximum fidelity. The proxy is a placeholder provided to serve as the user interface to a remote system. For example, the user may interact with proxy content to control a server that is editing full-resolution multi-gigabyte files. The proxy images are substitute images that may be displayed in place of the images. For example, the proxy images may be miniaturized images. As the video editor is utilizing the filmstrip to find and align to changes in the content, full fidelity may not be utilized. Careful selection of the coded and/or pre-filtering may maximize compression while providing the salient details to the editor to ensure maximum system performance. These proxies may be delivered progressively and in response to network and memory limitations so that the most optimal proxy is utilized at any given time and the system still provides useful placeholders when operating under severe limitations.

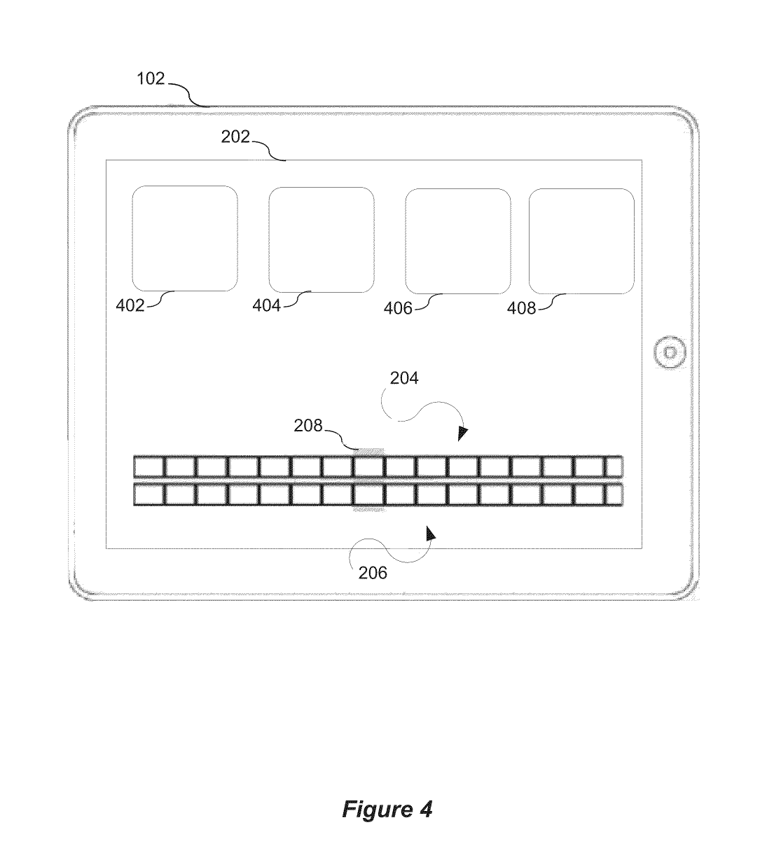

FIG. 4 illustrates a frame control configuration 400 with proxy images. In other words, the user may not want to see the rows of frames constantly. Accordingly, the user may select from a menu or assortment of proxy images, which are miniaturized images, displayed in part of the touch enabled GUI 202. For example, the proxy images may include a first proxy image 402, a second proxy image 404, a third proxy image 406, and a fourth proxy image 408. The user may select a proxy image, which would enlarge the proxy image and miniaturize the first video frame 204 and the second video frame 206. The proxy images may be other video tracks, other media content, or other content. The proxy image interface may be utilized with or without the frame control configurations provided for herein.

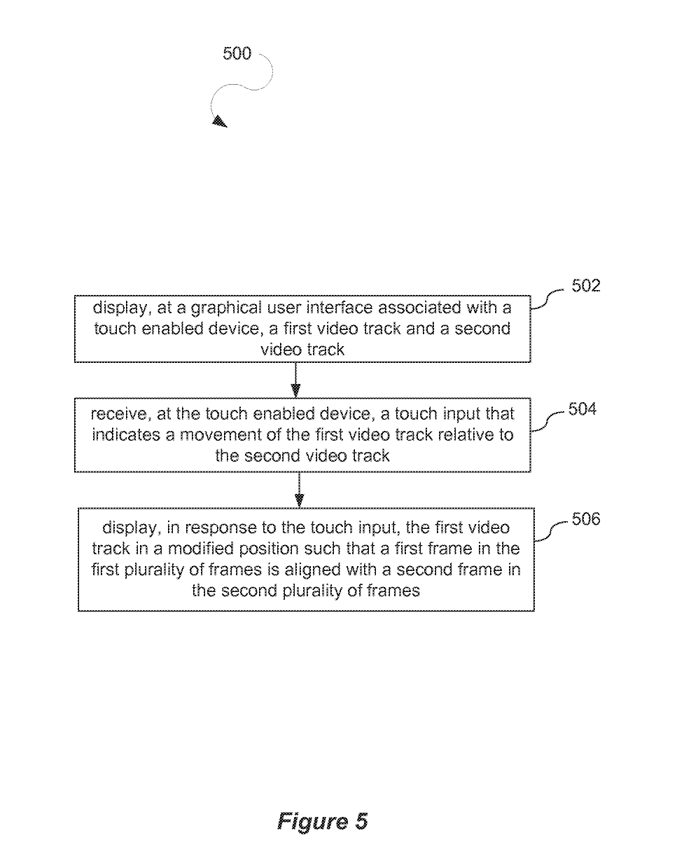

FIG. 5 illustrates a process 500 that may be utilized to provide frame control for a touch enabled device. At a process block 502, the process 500 displays, at a graphical user interface associated with a touch enabled device, a first video track and a second video track. The first video track includes a first plurality of frames and the second video track includes a second plurality of frames. Further, at a process block 504, the process 500 receives, at the touch enabled device, a touch input that indicates a movement of the first video track relative to the second video track. In addition, at a process block 506, the process 500 displays, in response to the touch input, the first video track in a modified position such that a first frame in the first plurality of frames is aligned with a second frame in the second plurality of frames. In one embodiment, the first plurality of frames is a first sequence in predetermined order and the second plurality of frames is a second sequence in a predetermined order. In another embodiment, the first plurality of frames is not in a predetermined order and the second plurality of frames is not in a predetermined order. In an alternative embodiment, the process 500 may also receive, at the touch enabled device, an additional touch input that indicates a movement of the second video track relative to the first video track such that the touch input and the additional input are received concurrently. In yet another alternative embodiment, such receiving is performed instead of the process block 506. The process 500 may be performed by sending the plurality of frames of a video track to a video editing computing device through a network, local connection, or the like. Further, the frames may be edited on the touch enabled device 102 and changes may be later sent to the video editing computing device for synchronization.

Although a first plurality of frames and a second plurality of frames are described and illustrated, any arbitrary number of tracks greater than two tracks may be utilized. Further, a single track of frames may also be utilized.

In another embodiment, the user may adjust the playback speed of an individual track by a direct gesture, an indirect gesture, a pressure-sensitive touchscreen, or by utilization of a contact-area on a capacitive touchscreen. For example, the user may very lightly touch the playing track with a pressure sensitive stylus to slow it down slightly. Alternatively, the user may drag his or her finger along with the playing video to speed it up or slow it down slightly.

Although the example provided herein have been for video/film editing, the gestures and manipulations provided herein may be utilized against any time-sequence content such as sound recordings, animation authoring, or motion control. The individual image frames may be utilized in such contexts. Further, generating and delivering appropriate and useful placeholders may be utilized in various domains.

In yet another embodiment, individual aspects of effects may be adjusted in addition to the alignment of frames, e.g., rotation, scale, and brightness correction. For instance, the frame control configurations provided for herein enable real-time rotoscopoing, animation, and sound editing.

In another embodiment, one or more foot pedals or foot-activated controls may be utilized to either triggers actions or provide fine control of playback. Examples of actions are start/stop, set marker, and set cue point. Further, an example of find control of playback is play slow.

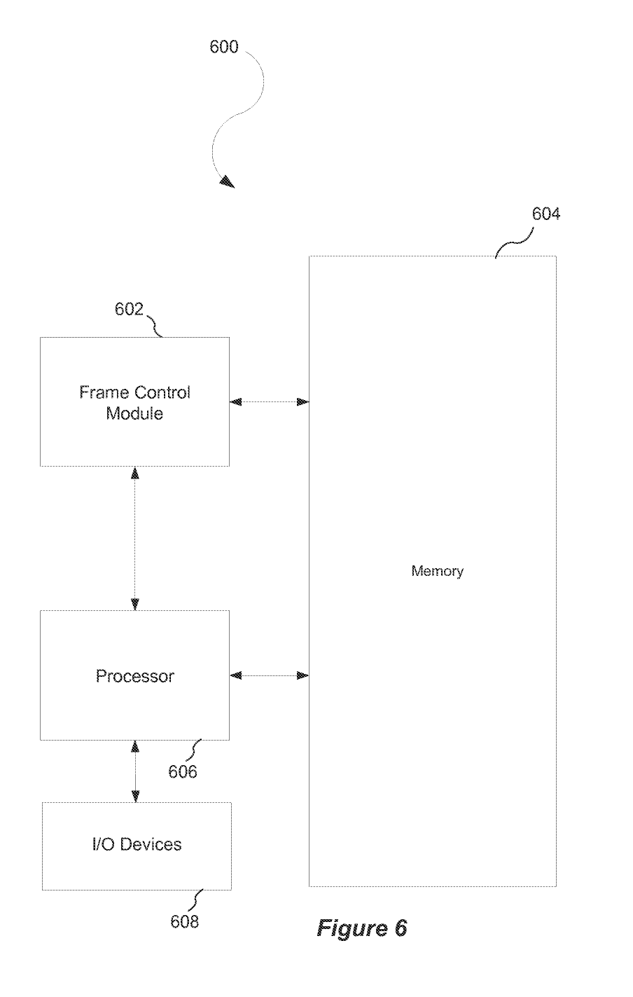

FIG. 6 illustrates a system configuration 600 that may be utilized to provide frame control. In one embodiment, a frame control module 602 interacts with a memory 604 and a processor 606. In one embodiment, the system configuration 600 is suitable for storing and/or executing program code and is implemented using a general purpose computer or any other hardware equivalents. The processor 606 is coupled, either directly or indirectly, to the memory 604 through a system bus. The memory 604 can include local memory employed during actual execution of the program code, bulk storage, and/or cache memories which provide temporary storage of at least some program code in order to reduce the number of times code must be retrieved from bulk storage during execution.

The Input/Output (“I/O”) devices 608 can be coupled directly to the system configuration 600 or through intervening input/output controllers. Further, the I/O devices 608 may include a touch interface, a keyboard, a keypad, a mouse, a microphone for capturing speech commands, a pointing device, and other user input devices that will be recognized by one of ordinary skill in the art. Further, the I/O devices 608 may include output devices such as a printer, display screen, or the like. Further, the I/O devices 608 may include a receiver, transmitter, speaker, display, image capture sensor, biometric sensor, etc. In addition, the I/O devices 608 may include storage devices such as a tape drive, floppy drive, hard disk drive, compact disk (“CD”) drive, etc. Any of the modules described herein may be single monolithic modules or modules with functionality distributed in a cloud computing infrastructure utilizing parallel and/or pipeline processing.

Network adapters may also be coupled to the system configuration 600 to enable the system configuration 600 to become coupled to other systems, remote printers, or storage devices through intervening private or public networks. Modems, cable modems, and Ethernet cards are just a few of the currently available types of network adapters.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above.

It should be understood that the processes and systems described herein can take the form of entirely hardware embodiments, entirely software embodiments, or embodiments containing both hardware and software elements. If software is utilized to implement the method or system, the software can include but is not limited to firmware, resident software, microcode, etc.

It is understood that the processes, systems, and computer program products described herein may also be applied in other types of processes and systems. Those skilled in the art will appreciate that the various adaptations and modifications of the embodiments of the processes, systems, and computer program products described herein may be configured without departing from the scope and spirit of the present processes, systems, and computer program products. Therefore, it is to be understood that, within the scope of the appended claims, the present processes, systems, and computer program products may be practiced other than as specifically described herein.

I claim:

1. A computer program product comprising a computer useable medium having a computer readable program, wherein the computer readable program when executed on a computer causes the computer to:
display, at a graphical user interface associated with a touch enabled device, a first video track and a second video track, the first video track including a first plurality of frames and the second video track including a second plurality of frames;
receive, at the touch enabled device, a touch input that indicates a movement of the first video track relative to the second video track; and
display, in response to the touch input, the first video track in a modified position such that a first frame in the first plurality of frames is aligned with a second frame in the second plurality of frames.

2. The computer program product of claim 1, wherein the computer is further caused to receive, at the touch enabled device, an additional touch input that indicates a movement of the second video track relative to the first video track such that the touch input and the additional input are received concurrently.

3. The computer program product of claim 2, wherein the computer is further caused to display, in response to the additional touch input, the second video track in a modified position such that the first frame in the first plurality of frames and the second frame in the second plurality of frames are aligned.

4. The computer program product of claim 1, wherein the computer is further caused to receive the first video track and the second video track through a network.

5. The computer program product of claim 1, wherein the first touch input is a first drag and the second touch input is a second drag.

6. The computer program product of claim 5, wherein results of the first drag and the second drag are displayed without inertia.

7. The computer program product of claim 1, wherein the computer is further caused to receive a cue point that identifies the first frame in the first plurality of frames and the second frame in the second plurality of frames.

8. The computer program product of claim 7, wherein the computer is further caused to play the first video track and the second video track from the cue point.

9. The computer program product of claim 1, wherein the computer is further caused to perform video editing over a network.

10. A method comprising:
displaying, at a graphical user interface associated with a touch enabled device, a first video track and a second video track, the first video track including a first plurality of frames and the second video track including a second plurality of frames;
receiving, at the touch enabled device, a touch input that indicates a movement of the first video track relative to the second video track; and
receiving, at the touch enabled device, an additional touch input that indicates a movement of the second video track relative to the first video track such that the touch input and the additional input are received concurrently.

11. The method of claim 10, further comprising displaying, in response to the touch input, the first video track in a modified position such that a first frame in the first plurality of frames is aligned with a second frame in the second plurality of frames.

12. The method of claim 11, further comprising displaying, in response to the additional touch input, the second video track in a modified position such that the first frame in the first plurality of frames and the second frame in the second plurality of frames are aligned.

13. The method of claim 10, further comprising receiving the first video track and the second video track through a network.

14. The method of claim 10, wherein the first touch input is a first drag and the second touch input is a second drag.

15. The method of claim 14, wherein the first drag and the second drag are displayed without inertia.

16. The method of claim 10, further comprising receiving a cue point that identifies the first frame in the first plurality of frames and the second frame in the second plurality of frames.

17. The method of claim 16, further comprising playing the first video track and the second video track from the cue point.

18. The method of claim 16, further comprising performing video editing over a network.

19. A touch enabled device comprising:
a graphical user interface that displays a first video track and a second video track, the first video track including a first plurality of frames and the second video track including a second plurality of frames, displays, in response to a touch input, the first video track in a modified position such that a first frame in the first plurality of frames is aligned with a second frame in the second plurality of frames, and displays, in response to an additional touch input that indicates a movement of the second video track relative to the first video track such that the touch input and the additional input are received concurrently, the touch input indicating a movement of the first video track relative to the second video track, the second video track being in a modified position such that the first frame in the first plurality of frames and the second frame in the second plurality of frames are aligned; and
a processor that calculates the movement of the first video track relative to the second video track.

20. The touch enabled device of claim 17, further comprising a reception module that receives the first video track and the second video track through a network.
